(19) United States
(12) Patent Application Publication
(10) Pub. No.: US 2006/0036556 A1
(43) Pub. Date: Feb. 16, 2006

(54) Postal printing apparatus and method

(76) Inventor: Peter Knispel, Arlington, TX (US)

Correspondence Address: Philip G. Meyers;Philip G. Meyers Law Office, Suite 300, 1009 Long Prairie Road, Flower Mound, TX, 75022, US

(21) Appl. No.: 10/916,876

(22) Filed: Aug. 12, 2004

(51) Int. Cl. G01G 19/413

(52) U.S. Cl. 705/407

(57) ABSTRACT

A method of processing a batch of mixed mail includes the steps of scanning each of the mail pieces to obtain the dimensions of the mail piece, using the mail piece dimensions to calculate an indicia print position on the mail piece, conveying the mail pieces to a printer; and moving a movable print head to the calculated print position and printing the indicia at the calculated print position.

### TECHNICAL FIELD

The invention relates to mail processing for delivery, and in particular, to a method of pre-processing mixed mail.

### BACKGROUND OF THE INVENTION

Currently in the United States many companies that produce mass mailings such as catalogues, brochures, magazines, advertisements and similar mailings rely on pre-sort mailers to prepare, bundle and deliver the mailing to the United States Postal Service (USPS). Preparation of a mass mailing includes pre-sorting the mail to different delivery zip codes, producing mailing lists and applying indicia such as bar codes and other markings to the individual mail pieces.

The process of pre-sorting mail requires the collection of information from the mail pieces and the printing or labeling of additional information on the mail piece. Such information includes the recipient addresses, identification codes such as zip codes, postal indicia such as stamp marks, permit indicia and/or Information Based Indicia Program (IBIP) indicia. Other information appearing on mail pieces may include Facing Identification Marks (FIM), bar codes, auto marks, identification codes, mail class and weight class. Most of this information has a designated location on the mail piece. For example, postage payment information is located in the upper right hand corner of the mail piece while the Postal Numeric Encoding Technique (POSTNET) bar code appears in a USPS specified zone on the bottom of the mail piece.

Processing mail pieces having varying dimensions (mixed mail) in a system that requires placement of specified information or indicia in a designated location on the mail piece requires additional processing steps insofar as some of the information has to be applied at different heights corresponding to the designated location on the mail pieces. For example, postage indicia must appear in a designated location at the upper right hand corner of the mail piece.

Since the height of the postage indicia relative to the base of a conveying device will vary in the case of mixed mail having varying dimensions, current practice is to apply postage indicia to mixed mail with a metering machine, by hand or during an additional pass through a mail sorting machine in which the mail pieces are fed upside down in order to print the postage indicia in the designated location. Sorting the mail pieces, gathering mailing information and applying a postal bar code and/or other indicia that must be applied in a designated area is performed as separate operation. The method and apparatus described herein are intended to eliminate the need for an additional pass through a mail sorting machine to apply indicia at locations measured from the upper edge of mail pieces having varying heights.

The method and apparatus described herein may be used in a variety of mail sorting applications. U.S. patent application Ser. No. 09/969,274 (Publication No. 20020070149) filed Oct. 2, 2001 for a Mixed Mail Sorting Machine, the disclosure of which is incorporated herein for all purposes, describes a mail sorter wherein the method and apparatus described below may be employed. In particular, the printer module described herein may be utilized as printer 124 of the mixed mail sorting machine.

### SUMMARY OF THE INVENTION

A method of processing a batch of mixed mail includes the steps of: a) scanning each of the mail pieces to obtain a mail piece image, b) processing the image to obtain the recipient address and the mail piece dimensions, c) using the mail piece dimensions to calculate a postage indicia print position on the mail piece, d) weighing each of the mail pieces on a scale and calculating the weight class of each mail piece and, e) moving a movable print head to the calculated print position and printing the postage indicia at the calculated print position.

In one embodiment, the method further includes singulating the batch of mail having varying dimensions to create a stream of individual mail pieces that are consecutively scanned. The method also includes printing a bar code on each mail piece in a designated clear zone. The bar code may be a POSTNET code, a PLANETCODE or another destination code. After processing, the mixed mail is sorted to a plurality of receptacles based upon a predetermined sort scheme.

### BRIEF DESCRIPTION OF THE DRAWINGS

FIG. 1 is a view of the address side of a typical pre-sort mail piece;

FIG. 2 is a schematic representation of a system for processing pre-sort mail; and

FIG. 3 is a partial side view of a printer suitable for use in the method of the invention.

### DETAILED DESCRIPTION

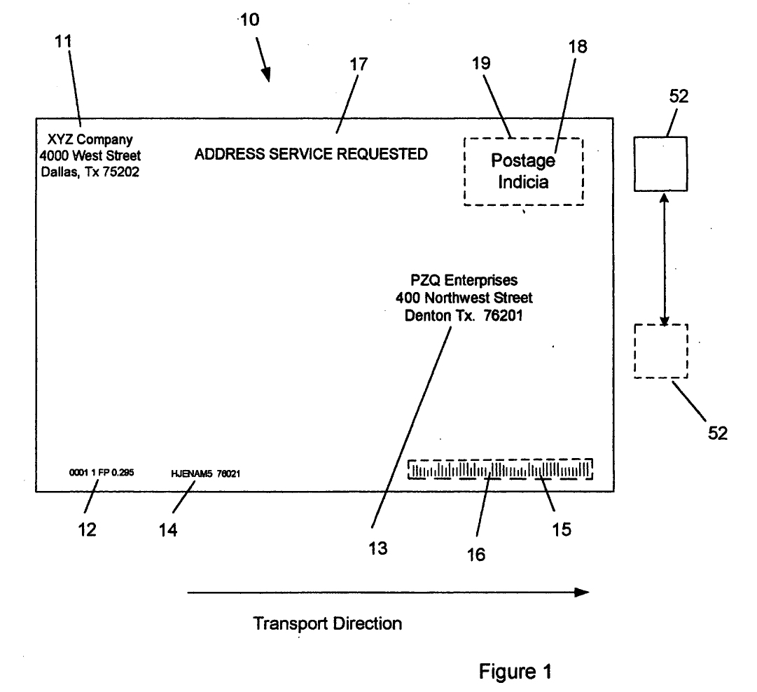

Referring now to FIG. 1, a typical layout for pre-sort mail piece 10 includes the sender's return address 11 in the upper left hand corner of the mail piece and the recipient's address 13 on the right hand side on the address side of the mail piece. The mail piece also includes postage indicia 18 printed in a zone 19 that is designated by the USPS. The location of postage indicia 18 is indexed from the top and right side of the mail piece. Postage indicia 18 must be printed in the upper right hand corner of the mail piece at least 0.25 inches from the top and right edges of the mail piece. Indicia 18 must be oriented with the longest dimension parallel to address 13 and must not infringe on areas reserved for the Facing Identification mark (FIM), the bar code clear zone 15 or the OCR clear zone.

Mail piece 10 also bears a bar code 16 printed at a location on the mail piece that is indexed from the bottom and right hand edges of the mail piece. Bar code 16 may be a POSTNET code, a PLANETCODE, a 4-state bar code or another identifier. In accordance with postal specifications, bar code 16 is printed 0.25+0.0625 inches from the bottom edge of the mail piece within bar code clear zone 15. Bar code clear zone 15 is a rectangular area extending inward of the right and bottom edges of the mail pieces with top and left edge boundaries defined by the USPS Domestic Mail Manual (DMM). Other indicia appearing on pre-sort mail piece 10 include manifest key line information 12 and auto marking 14. Auto marking 14 includes a five digit zip code and an alpha numeric identifier of the OCR, the mail class and weight class. Finally, the mail piece 10 may include an endorsement 17. In accordance with the invention, postage indicia 18, bar code 16 and optionally, key line manifest information 12 and auto marking 14 are applied to mail piece 10 in a single pass sorting operation.

Turning now to FIG. 2, an apparatus 30 suitable for applying both bar code 16 and postage indicia 18 in a single pass sorting operation includes a singulator 32 for separating a stack of mail pieces having varying dimensions into a stream of individual mail pieces 20. Singulator 32 includes one or more take off rolls 34 that direct the individual mail pieces to a conveyor 33 that transports mail pieces 20 along a mail path through apparatus 30. Mail pieces 20 are first transported past a scanner 36 which includes an optical character reader (OCR) 38. Scanner 36 scans destination information appearing on the address side of each mail piece 20 and determines the dimensions of the mail piece. The destination information and the dimensions of each mail piece 20 are transmitted to a system control computer 40 for use in connection with a predetermined sort plan for downstream sorting of the mail pieces. The dimensions of the mail pieces are also stored on system control computer 40 for use in connection with printing postage indicia 18 on each mail piece.

System control computer 40 also determines the speed of mail pieces 20 traveling through apparatus 30 by direct measurement or calculation and measures or calculates the gap between succeeding mail pieces. Instrumentation, systems and methods for measuring and/or calculating the speed of mail pieces 20 and the gap between individual mail pieces are well known in the art. After mail pieces 20 have been scanned, the mail pieces are transported to a scale 42 which weighs the mail pieces as the pieces move across the scale and electronically transmits the weight of each mail piece to system control computer 40. U.S. patent application Ser. No. 10/251,625 (Publication No. 20040055790), for a Method for Weighing Mail Pieces to Gerstenberg et al., the contents of which are incorporated herein for all purposes, discloses method for weighing mail pieces conveyed through a weighing module that may be utilized in connection with mail pieces 20.

After weighing, mail pieces 20 are then carried to a bar code printer 44 where bar code 16 is printed on each mail piece 20 based on information transmitted to bar code printer 44 by system control computer 40. Optionally, bar code printer 44 also applies key line manifest information 12 and auto marking 14 to the mail pieces. After bar code 16 has been applied, each mail piece 20 is conveyed past a bar code scanner 46 which scans bar code 16 and communicates with system control computer 40 to verify that the bar code applied to each mail piece 20 is correct.

After bar code 16 has been verified, mail pieces 20 are conveyed to a postage indicia printer 50. System control computer 40 utilizes the previously collected and stored destination information along with the mail piece weight to determine the appropriate postage indicia 18 for each mail piece 20 and transmits the information to a postage indicia printer 50. For example, the mail piece class may be determined from a combination of operator inputs, results of the OCR scan and from the weight of the mail piece 20. In embodiment, printer 50 is connected to a postage metering device such that printer 50 applies indicia 18 evidencing prepayment of postage to mail pieces 20.

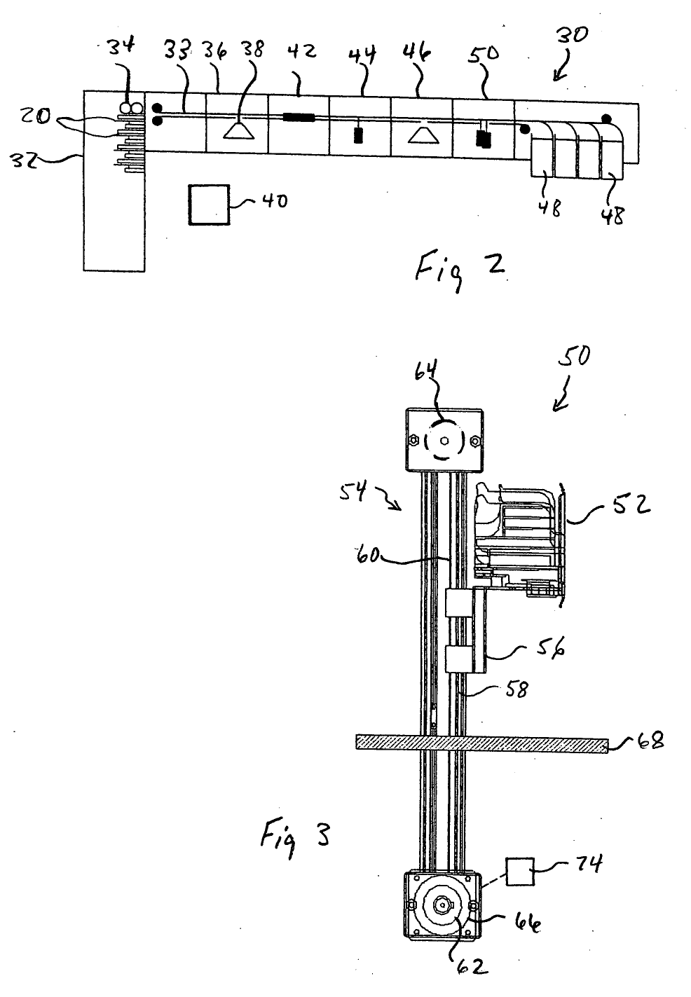

Since the vertical dimensions of mail pieces 20 vary, printer 50 must be capable of printing postage indicia 18 at different vertical positions corresponding to the specified location 19 for each mail piece. For example, the print head 52 (FIG. 3) of printer 50 may be required to move between the positions indicated in FIG. 1 in order to apply postage indicia 18 on succeeding short and tall mail pieces 20 in the designated zone 19 on the mail pieces.

Turning to FIG. 3, to provide the capability of printing at different heights, printer 50 includes a vertical belt driven linear drive assembly 54 configured to move print head 52 in a vertical direction so as to apply postage indicia 18 in the specified location 19 on succeeding mail pieces 20 having differing heights. As shown, print head 52 is mounted on a carriage 56 that moves vertically along a pair of rails 58 (one shown) to position print head 52. Carriage 56 is attached to an endless timing belt 60 that passes around drive pulley 62 and an idler pulley 64. Drive pulley 62 is driven with a motor 66 to move carriage 56 and print head 52 along rails 58 to vertically position print head 52 at the desired height above transport base plate 68.

A motion controller 74 which may be a program linear controller or other microprocessor based computer, communicates with system controller 40 to control the operation of linear drive assembly 54. Since one complete rotation of motor 66 moves print head 52 a known distance, motion controller 74 can utilize an encoder or similar device coupled to motor 66 to control the operation of motor 66 and the vertical movement of print head 52 along rails 58. Alternatively, linear drive assembly 54 may be directly controlled by system control computer 40, depending upon the particular design and application.

In one variation, system control computer 40 transmits the dimensions of each mail piece 20 to linear motion controller 74 which determines the vertical position for print head 52 required to apply postage indicia 18 in the designated zone 19 on each mail piece 20. The height of print head 52 relative to transport base plate 68 required to apply postage indicia 18 at the correct location on a given mail piece 20 is calculated as follows:
Iₕ=MP_{height}+MP_{tansgap}−C_{zu}
where: Iₕ=Height of upper line of postage indicia
MP_{height}=Mail piece height
MP_{tansgap}=Gap between mail piece and base of transport.
C_{zu}=Upper clear zone between postage indicia and upper edge of mail piece (approximately 6 mm).

Typically, mixed mail is sized between 89×127 mm (3.5×5 inches) to 254×356 (10×14 inches). Assuming that the gap between the transport base plate 68 and the bottom edge of the mail piece is approximately 5 mm, Iₕ for the minimum sized mail piece having a height of 89 mm is 88 mm while the value of Iₕ for the maximum sized mail piece having a height of 356 mm is 355 mm. Thus, in the worst case, print head 52 will be required to move a vertical distance of 267 mm (355 mm-89 mm) between succeeding mail pieces 20 to print postage indicia 18 in the designated areas 19 on the mail pieces.

In order to actuate printer 50 when a mail piece 20 is properly positioned for application of postage indicia 18 with print head 52, the time required to position print head 52 for succeeding mail pieces of different dimensions is calculated as follows:
Tₘₒᵥₑ=(((MP1₁−LCZ_{MP1}−I_{MPIL}+G_{L}+LCZ_{MP2})/V_{MP})−Sₜ)
Where: Tₘₒᵥₑ=Time to move from print position for mail piece 1 to the print position for mail piece 2;
MP1₁=Length of mail piece 1;
LCZ_{MP1}=Length of clear zone between the leading edge of mail piece 1 and the postage indicia applied to mail piece 1;
I_{MPIL}=Length of the indicia applied to mail piece 1;
G_{L}=Gap length between mail piece 1 and mail piece 2;
LCZ_{MP2}=Length of clear zone between the leading edge of mail piece 2 and the postage indicia applied to mail piece 2;
V_{MP}=Travel speed of the mail pieces; and
Sₜ=Stabilization time for print head.

The information required to calculate Tₘₒᵥₑ is available to system control computer 40. The speed of mail pieces 20 and the gap length between the mail pieces have previously been determined and stored on system control computer 40. The length of the clear zone between the leading edges of succeeding mail pieces 20 and postage indicia 18 applied to mail pieces 20 is calculated based on the scanned dimensions of the mail pieces. The length of the postage indicia 18 applied to each mail piece 20 may be one or more fixed values, depending upon the particular indicia applied, that are stored on system control computer 40. Alternatively, the length of the indicia 18 may be recorded as the indicia is applied to each mail piece 20 and transmitted to system control computer 40 and/or stored on linear motion controller 74. Thus, system control computer 40 can calculate the time at which a given mail piece 20 will be properly positioned at printer 50 to receive postage indicia 18 and activate the printer accordingly. Alternatively, a sensor such as a photocell or proximity switch may be used to sense when the mail piece 20 is properly positioned and signal system control computer 40 to activate printer 50.

After postage indicia 18 has been applied to mail pieces 20, the mail pieces are sorted to a series of receptacles such as bins 48, based upon a pre-defined sort plan implemented with the information stored on system control computer 40 for each mail piece 20. For example, the mail pieces may be sorted by ZIP+4 code for delivery to a local or regional USPS distribution center. In some cases it may be desirable to further sort mail pieces 20 by size, weight or class, in which case these parameters are incorporated into the pre-defined sort plan or scheme and implemented with the information stored on system control computer 40. System control computer 40 may also generate a mailing list, including the names and addresses of mailers and recipients, codes associated with the mailers and recipients, the total number of pieces in a given mailing, number of mail pieces directed to different zip codes, the postage applied to each mail piece and/or the total postage associated with a mailing and other information that may be of use to the pre-sort mailer or the postal service.

While the invention has been described in connection with the exemplary embodiments it will be understood that the invention is not limited to the specific embodiments shown. For example, an alternative linear drive, such a spindle type drive may be substituted for the belt drive used to position print head 52 of printer 50. Thus, it will be appreciated by those skilled in the art that modifications, combinations, methods, and subcombinations of the invention may be made without departing from the spirit and scope of the appended claims.

1. A method of processing a batch of mixed mail comprising:
scanning each of the mail pieces to obtain the dimensions of the mail piece;
using the mail piece dimensions to calculate an indicia print position on the mail piece;
conveying the mail pieces to a printer; and
moving a movable print head to the calculated print position and printing the indicia at the calculated print position.

2. The method of claim 1 further comprising processing the image to obtain the recipient address.

3. The method of claim 2 further comprising weighing each of the mail pieces on a scale and calculating the weight class of each mail piece.

4. The method of claim 3 wherein the indicia is postage and wherein the method includes calculating the amount of postage required for the mail piece.

5. The method of claim 4 further comprising printing a destination bar code on each mail piece and sorting the mail pieces to a plurality of receptacles based upon a predetermined sort scheme.

6. A method of processing a batch of mixed mail comprising:
scanning each of the mail pieces to obtain a mail piece image;
processing the image to obtain the recipient address and the mail piece dimensions;
using the mail piece dimensions to calculate a postage indicia print position on the mail piece;
weighing each of the mail pieces on a scale and calculating the weight class of each mail piece; and
moving a movable print head to the calculated print position and printing the postage indicia at the calculated print position.

7. The method of claim 6 further comprising the step of singulating the batch of mail having varying dimensions to create a stream of individual mail pieces.

8. The method of claim 6 further comprising printing a destination bar code on each mail piece in a designated clear zone.

9. The method of claim 8 further comprising the step of verifying the bar code on each of the mail pieces.

10. The method of claim 8 wherein the bar code is a POSTNET code.

11. The method of claim 8 wherein the bar code is a PLANETCODE.

12. The method of claim 8 further comprising the step of sorting the mail to a plurality of receptacles based upon a predetermined sort scheme.

13. A mail sorting apparatus comprising:
a singulator for separating a stack of mail pieces having varying dimensions into a stream of individual mail pieces;
a scanner for determining the dimensions of each mail piece;
means for applying an indicia to each mail piece, the indicia being applied at different heights relative to the bottom edge of the mail piece;
a processor for determining the print head position required to print an indicia at a predetermined position on each mail piece, the print head position being determined based upon the dimensions of the mail piece, the processor signaling the printer to position the print head; and
at least one bin for receiving the mail pieces.

14. The apparatus of claim 13 wherein the means for applying an indicia is a printer including a moveable print head.

15. The apparatus of claim 14 further comprising a linear drive for moving the print head.

16. The apparatus of claim 13 further comprising a scale for weighing each mail piece.

17. The apparatus of claim 16 further comprising means for determining destination information for each mail piece.

18. The apparatus of claim 13 wherein the indicia is postage and wherein the apparatus further comprises means for determining the postage to be applied to each mail piece.
